(19) United States
(12) Patent Application Publication
(10) Pub. No.: US 2005/0097105 A1
(43) Pub. Date: May 5, 2005

(54) Distributed database for one search key

(76) Inventor: Jari Ranta, Espoo (FI)

Correspondence Address: KIRKPATRICK & LOCKHART NICHOLSON GRAHAM LLP, 535 SMITHFIELD STREET, PITTSBURGH, PA, 15222, US

(21) Appl. No.: 10/502,165

(22) PCT Filed: Feb. 6, 2002
(86) PCT No.: PCT/FI02/00086

(51) Int. Cl. G06F 7/00

(52) U.S. Cl. 707/10

(57) ABSTRACT

Method and arrangement for storing information in data network into a network element in accordance with a hash value of the search key; and a method adding a new element using overlapping hash values for the primary and secondary element to keep the service available during the element adding process and in case of hardware failure.

The invention relates to a fail-safe database using one search key.

The aim of the invention is to improve the reliability and performance of a database optimised for one search key. This type of databases are needed for e-mail servers, telecom service provision systems etc, for storing user data.

The mail server's database for user data must be scalable from a small 100 entry system to a multi-million user system. Also, if one component in the network is down, the service should still work with adequate speed. The known technology is a hot-swap system for providing backup. This system means however, that half of the hardware is only waiting for something to break down. Backing up the files is usually not easy, because the server is in heavy use all the time, and no downtime is allowed.

The purpose of the invention is to provide a data storage that is scalable, has redundancy to provide high reliability, is easy to enlarge by adding new hardware, is fault-proof, and wherein disconnecting or removing a server will not cause downtime. The database according to the invention does not have any stand-by units, but all servers act as primary and secondary servers at the same time. This is economically a good way and also all units are in real use, and this is also more reliable, because in electronics the faults typically appear more frequently at the beginning of the life-time. In this way, there are no potentially weak stand-by units being almost unused. Also, the network topology supports high reliability in such a way that the primary server and secondary server are always in different clusters of the network, so that half of the network may be down and this will only slow down the service. Load balancing is also simple and ensures efficient use of disk space.

There is also no need to store the location of the user data, because the position can be calculated quickly from the search key by a hash function. When data is to be read, the search key alone suffices to generate the address of the data in the network. Because a proper hash function is pseudo-random, the data is divided evenly on the nodes automatically. The data is stored in normal separate files that are easy to handle with normal text tools or normal operating systems tools. No binary databases are needed for good performance. Hashing of a search key is a well-known method for organising information within a database. This invention provides high reliability and good scalability as well as ease of building a large, high-performance system from off-the-shelf parts and inexpensive hardware. The characteristics of this invention are disclosed in the accompanying claims.

The figures are referred to for explanation of the logical functionality of invention.

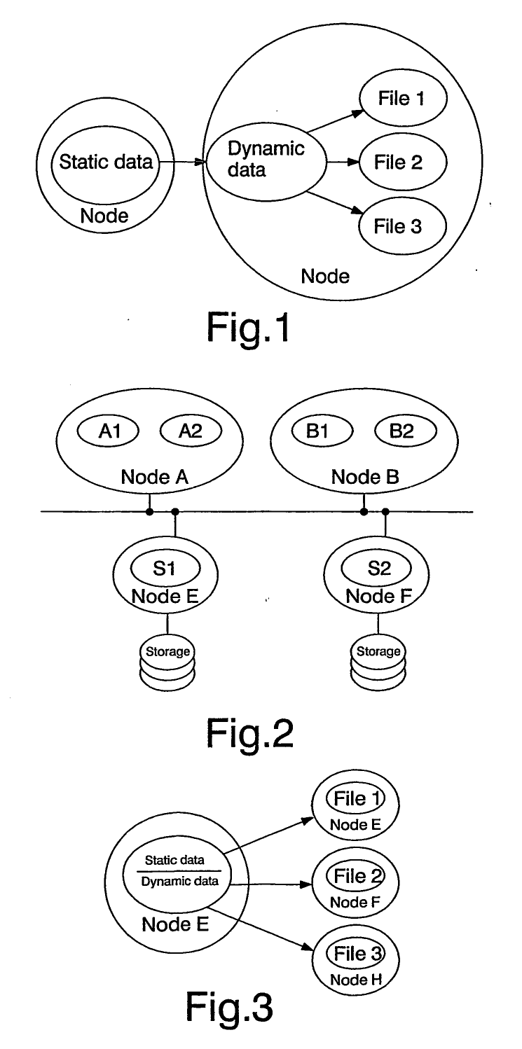

FIG. 1 shows a prior art solution

FIG. 2 shows elements of a distributed database

FIG. 3 shows logical elements in a system according to FIG. 2

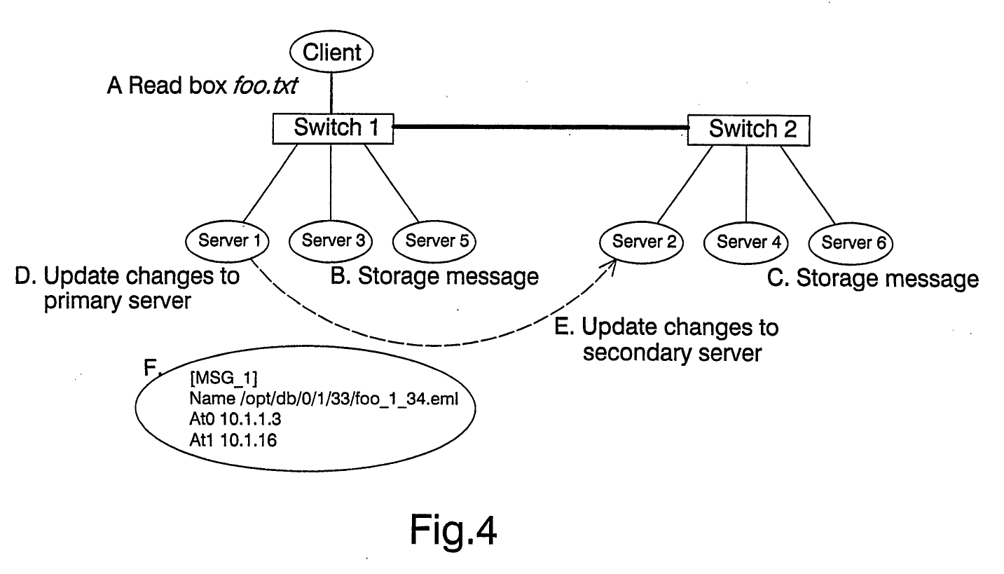

FIG. 4 shows the operations that are done when a file is stored in the cluster.

In FIG. 1, dynamic data and the files form a unit which is logically and physically the same, and the static data forms another logical unit that contains the information on the location of the dynamic data. The dotted circles around them illustrate these units. Static and dynamic data are, therefore, tightly coupled, that is, the dynamic data cannot be moved to a different location without changing the pointer in the static data.

Now consider a system with millions of users that would be divided between several machines. In order to find the dynamic data for user A, there has to be information in the static database in which user A is. When more capacity is required for handling more users, a new node should be added. When a new node is added, it will be empty until new users are added or moved into it. When a user is moved from one unit to another, the database must be changed and the users' dynamic data should be moved as well. Since there may be a large amount of data in the files, users are seldom moved. Instead, the new node will be empty until new users are added. Moving user data to balance the usage of nodes brings on much extra work. Deleting and moving the users fragmentises the database and deteriorates performance.

If this large system is to be highly available, then all data should be backed up regularly on high-capacity tape. When a disaster occurs, the data can be restored from this tape. Backing up messages and restoring them is time-consuming, and the system must be shut down for maintenance at least for the duration of the restoring. During this time the services are not available regarding the failed units. It should be noted that when the amount of data increases, the backup operation becomes a tedious process. For example, large e-mail servers typically have terabytes of storage and, therefore, the backup operation takes a long time. Even if the backup can be done without shutting down the system, it uses system resources and thus degrades service quality for other users. Backing up the system also requires extra work for carrying out the actual backup operation. Backup always restores the system to the point of backup, not to the point of failure. Therefore, all changes that are not backed up after the last backup are lost forever.

The solution for creating an automated backup and distributed simple system without storing key values is to use a hash of the search key to define the element in which the related information is stored. The backup copy is written, for example, to the server with the next hash code. The data is first read from the first server, and if that fails, then the secondary backup server is tried. In this way, all servers are primary servers for some files and secondary for certain others. If the number of servers is changed intentionally, the data records are still found from both servers and the files can be moved to a new server as a background process without stopping the service, because at least one of the old servers is always a primary or secondary in a new hash value because of overlapping hash values in new and old configurations.

FIG. 2 shows a distributed system according to the invention. Two servers S1 and S2 are in nodes E and F, clients A1 and A2 are in the node A and clients B1 and B2 in the node B. The amount of clients and servers is a fraction of a large system according to the invention.

FIG. 3 shows relationship of static and dynamic data in the system according to the invention. They form a single logical unit that is physically distributed. The files are distributed over the network automatically. The hashing allows users to find the data pointing to the files automatically without a large and vulnerable database.

FIG. 4 shows the steps to store a message and the data that is added in the box. Solid lines illustrates network connections and the dashed line illustrates an operation. The cluster has two switches, each switch has three servers. The client is connected to switch 1.

Step A. Client locates the box for user foo using the hash function and retrieves a copy of the box from server one.

Step B. Client randomly picks node from network segment that contains only odd numbered servers and stores a file in server three. Client generates a unique filename by using a box dependent part, a message identifier based on a counter that is held in the box, and a random number.

Step C. Client randomly picks node from network segment that contains only even numbered servers and stores the file in server six using the same filename as in step B.

Step D. Client updates the changes of the box to the primary server. Only the changed parts in the box are updated. Primary server collects the changes and modifies the contents of the box accordingly.

Step E. Primary server copies the changes of the box to the secondary server. If the secondary server is down, a one line entry is stored in a journal saying that the box foo.txt should be copied to secondary server.

Step F. This figure shows part of the data that was added into the box. Note that the data contains the Name of the message and two IP-addresses that give the physical location of the message in the network.

The servers are advantageously organised in such a way that odd and even hash values point to different segments in the network, so that secondary and primary servers for each subscriber are behind different switches. The backup copy should be stored in the server having the next higher or lower address number the hash value refers to. This keeps half of the system running if the other half is out of use and the system will still be available. In this way there will always be a valid copy in both odd and even server numbers that are in different segments of the network.

When a server starts, it asks for a configuration file from another server. After this it will know the configuration of the servers and the directory structures, and the server will be able to start the necessary processes, if a new server (either itself or another server) is found.

When a client wishes to access the system, it asks for the information on the network from any available server. The IP-address or other type of identification of at least one server is the only configuration information that the client needs to access the system. The information from the server gives the convention of file names, which the client should be using for different user files. Also the hash table or the rule to generate a hash table is passed at this time.

The subscriber information is stored in a “box”, which holds information on the subscriber and pointers of the files of the subscriber. Session-related information can be stored in RAM (Random Access Memory) only; this reduces the amount of disk I/O. The primary copy is in a server, which is pointed by the subscriber information of the search key of some other type, and the secondary copy is, for example, in the server under the next higher hash number. When a client asks for a change to be made in the box, the primary server passes the changes on to the secondary server. During the box-changing procedure, the server does not accept new modifications to the same box until the first transaction has been completed. If contacting the primary server fails, or if the box is unavailable, the client will automatically try the secondary server. Once the primary server is available again, it asks for the changes from the neighbouring servers. It needs to ask for the changes from those servers that are either its primary or secondary servers. If the backup copy is in the next server, only the neighbouring servers need to be asked for the list of changes. This list is called a journal.

In FIG. 2, the system is distributed over a network, the nodes of the servers (S1, S2) are found by hashing the search key as described. The user files are further distributed as shown in FIG. 3. The address of the static and dynamic data is found by a search key, the location of the server is found by the hash function of the search key and further by using the search key to find a “box” in the server. The box holds both static and dynamic data. The box has pointers to user files (file 1, file 2, file 3) which are randomly distributed over the network to ensure load-balancing. The static and dynamic data can be moved without moving the user files on file servers, and the static and dynamic data is automatically copied on two servers, as was stated above.

During the time the secondary server is down, or the box in the secondary server is unavailable, the primary server knows that it is down and it needs to keep a journal during the downtime. When the secondary server gets up, it requests for the changes and updates itself. The primary server can advantageously give information on the downtime of the neighbouring server to the system. In this way, the missing server is not tried in vain.

When a new server is added to the system, the new server is configured with the IP-number of at least one other server. The server requests for the configuration information from that server, and receives a list of the other servers. After that, the new server requests all other servers to start a process of moving the boxes to new locations according to the new hash table. If there is a previous server-adding process still going on, the new server will wait for it to finish. This adding process moves only the boxes that need to be moved. The simplest way to reorganise the boxes is to calculate the new and old hash value for each box and to move those boxes, which are in the wrong server. In case of multiple servers, this process moves only a fraction of the files, because in most cases, either a backup copy of the primary copy or the box is already in the server. During the adding process, servers take care of database integrity in basically the same way as in the case of a missing server. During the process, the client gains access to both old and new hash values, because the moving of the boxes always takes place between neighbouring numbered servers; at least one server with both new and old hash values is always a valid primary or secondary server. If a client uses a “wrong” hash version, the missing box causes additional questioning from the neighbouring server. The clients receive information on the change in the cluster configuration each time they attempt to gain access to a box. Advantageously, a client receives, for example, a version number of a configuration and knows it can ask for new configuration information from any server.

Removing a server also results in a reorganisation process in all the servers, which is basically the same as adding a server, but in the opposite direction. Once the boxes have been moved to new locations, the server may try to shut down. If there still exist stored user files, the shutdown is not allowed and it is attempted in next housekeeping operation which takes care of expired files. The files may be moved if necessary, but typically the shutdown will take place after a long time, because usually it is easier to wait for most of the user files to expire than to move them all to other servers. Moving the files means updating the boxes in the primary and secondary servers and moving the files to new location. The user files are explained in more detail below.

The boxes have the pointer to files related to the search key, for example mail or message systems subscriber files, like mail messages, drafts, stored files, etc.

The box works like a directory list for the files. The box is advantageously a text file that is easy to recover and a text file is easier to edit with maintenance scripts, if necessary. The files are stored in the system also in a random or pseudo-random manner. The files may be in any form, for example, as text or voice messages. The file servers may be the same or other servers than the box servers. If a system has a very high amount of file capacity in a small number of boxes, it is advantageous to have dedicated file servers in the system. If the amount of dynamic information in the boxes is in very intensive use compared to the files, it is good to have dedicated servers for the boxes only. The files in the file servers are not changeable; they may only be stored, deleted or moved. In case of a mail or message system, the messages are stored as separate files.

The backup strategy may depend on the usage or purpose of a system. If necessary, the system will copy user files to two or more servers. Typically, files do not live for a very long time, which means that an additional backup process is very seldom needed. Most cases even the file duplicates to other servers are not necessary for normal user. In case of hardware failure some random files will be lost to many of the users. The system will still be able to detect the loss of messages, because the pointers to the files are duplicated. The backup strategy may vary according to the user and the file type. In case of a server breakdown, it is possible to copy the remaining duplicates on demand to other servers to maintain the high reliability of the files. This is typically not done in a message system, because the files will in any case expire within a short time.

Files are stored in file servers by request of clients, and the file pointer is stored in the box. The client obtains the correct path and file name for storing by asking the format from the box-keeping server. The full name can be asked in advance from the box-keeper or it can be derived by a rule passed in the initialisation file of the client in start-up. The files are stored inside a directory structure, so that files of different users may be in the same directory and the prefix of the file name will identify the user of the file. In this way, it is easy to use a hash function to generate a directory path for storing the files, and files may be stored with a random client-dependent part in the file name to ensure unique file names. The random part in file names makes it possible to generate the proper file name without asking it from the server in advance, and the risk of two processes using the same file name in the same directory at the same time before the updating of the file name in the box is very small. For example with 16 servers and a 16-bit random part, the likelihood is less than 1/million, and the timeslot for the coincidence is at most 100 milliseconds. The client may store the file in two (or more) servers. The file address stored in the box includes at least the address of the primary server, the path and the file name. The secondary server's address can be derived from the primary server's address. Advantageously, the same rule can be used as with the boxes. The network may also be divided into segments, which include odd and even servers as with boxes.

Load balancing for file saving is done by randomising the server and the directory in which the file is written. The directory typically defines the physical disk inside a server. The range of different servers/directories is proportional to their disk space, or free disk space if disks have been added lately. Individual clients randomly share storage space in this way without any outside control. In tests, this simple approach has proven to be very useful. Adding more capacity is very simple. The only configuration information for a new server is an IP-number or other type of address of any server in the system, the rest of the work is carried out automatically amongst the servers. The system is available continuously during the upgrading process, without any human intervention.

The characteristic of the invention is indicated in the independent claims, the favourable embodiments are presented in the subclaims.

1. A distributed database using multiple network nodes and a search key referring user data, characterised in that the search key is used as an argument for a hash function to generate a pseudo-random key for pointing to an individualised node for storing the data in the network.

2. A distributed database according to claim 1, characterised in that each record is stored automatically in at least one primary node and in at least one secondary node, the said hash function values being used to point to primary and secondary nodes, so that data is accessed from the secondary node in case of failure to access the data from the primary node.

3. A distributed database according to claim 2, characterised in that each record is automatically stored in nodes with successive hash values.

4. A distributed database according to any of the preceding claims, characterised in that each node acts as a primary and as a secondary node at same time for different search keys.

5. A distributed database according to any of the preceding claims 2 to 4, characterised in that the changed data is automatically copied between the primary and secondary nodes by the servers in the nodes.

6. A distributed database according to any of the preceding claims 2 to 5, characterised in that the data stored the primary and secondary nodes contains pointers to elements in the network for storing user files and copies of user files.

7. A distributed database according to any of the preceding claims 2 to 6, characterised in that adding a node in the system is done by moving the records with a changed hash value for a primary or secondary node to the location according to the new hash value, and the primary node and secondary node together maintain the service available for both new and old hash value searches by using overlapping primary and secondary server hash values to ensure access for clients during the move, and the nodes keep a list of changes that could not be updated in either primary or secondary copy of the record in the corresponding node.

8. A method for storing and accessing information in a multi-computer environment, characterised in the steps of calculating the hash function of the search key for the information; determining the node with the hash function value of the search key; determining a secondary node from the said hash function value for determining a secondary node for backup; storing the information in the servers in the primary and secondary node; accessing the information by calculating the hash value of the search key and accessing the node with the hash value or with the secondary hash value.

9. A method for adding a server in a system functioning according to claim 8, characterised in the steps of calculating new hash values for servers, calculating new and old hash values for each file to be possibly moved; moving the files which should be in a different server according to the new hash value.

10. A method for accessing the files during the server adding operation according to claim 9, characterised in the use of hash values which overlap for primary and secondary servers' addresses for new and old configurations in such a way that always either the primary or the secondary server is found with the old hash value, even if the data has already been moved to the new server.
